(19) United States
(12) Patent Application Publication
(10) Pub. No.: US 2026/0067603 A1
(43) Pub. Date: Mar. 5, 2026

(54) SMART WEARABLE EYEGLASS TEMPLE AND SMART WEARABLE EYEGLASS INCLUDING THE SAME

(71) Applicant: AAC Microtech (Changzhou) Co., Ltd., Changzhou City (CN)

(72) Inventors: Zhiwei Zhong, Changzhou (CN); Xin Jin, Changzhou (CN); Wei Song, Changzhou (CN)

(21) Appl. No.: 18/984,872

(22) Filed: Dec. 17, 2024

Related U.S. Application Data
(63) Continuation of application No. PCT/CN2024/117019, filed on Sep. 5, 2024.

(51) Int. Cl. H04R 1/02; G02C 5/14; G02C 11/00; H04R 9/02; H04R 9/06

(52) U.S. Cl. CPC H04R 1/028; G02C 5/14; G02C 11/10; H04R 1/025; H04R 9/025; H04R 9/06; H04R 2400/11

(57) ABSTRACT

The present disclosure discloses a smart wearable eyeglass temple, including a housing including an inner surface and a support wall extending from the inner surface, a speaker unit including a frame mounted on the support wall, a vibration system having a diaphragm, and a magnet system. The frame has a first width along a first direction perpendicular with a vibration direction of the diaphragm. The inner surface has a second width along a second direction intersected with the first direction and located in a same plane with the first direction. The first width is larger than the second width. The present disclosure further discloses smart wearable eyeglass including the smart wearable eyeglass temple.

### FIELD OF THE PRESENT DISCLOSURE

The present disclosure relates to smart wearable eyeglass device technologies, especially relates to a smart wearable eyeglass temple and a smart wearable eyeglass including the same.

### DESCRIPTION OF RELATED ART

VR eyeglass is a wearable eyeglass enabling sound playing, which generally includes a eyeglass frame and two eyeglass temples mounted on the eyeglass frame.

In related art, a cross section of the eyeglass temple is rectangular. A speaker unit is received inside the eyeglass temple for sound playing. For comfort and esthetical appearance, a width of the eyeglass temple is usually expected to be smaller. Accordingly, a width of the speaker unit would also be smaller, thus resulting in reduction of the volume of the magnet and the vibration area of the diaphragm of the speaker unit.

Therefore, it is necessary to provide an improved smart wearable eyeglass temple to overcome the problems mentioned above.

### SUMMARY OF THE INVENTION

One object of the present disclosure is to provide a smart wearable eyeglass temple with higher acoustic performance and smaller size.

The smart wearable eyeglass temple includes a housing having a receiving space and a sound hole penetrating thereon, including: an inner surface enclosing the receiving space; and a support wall extending from the inner surface; a speaker unit received in the receiving space, including: a frame mounted on the support wall; a vibration system mounted on the frame, including: a diaphragm for generating sound, dividing the receiving space into a front sound cavity and a back sound cavity, and including an edge fixed on the frame; a magnet system configured to drive the vibration system, received in the back sound cavity; wherein the sound hole is configured to connected the front sound cavity with outside; the frame has a first width along a first direction perpendicular with a vibration direction of the diaphragm; the inner surface has a second width along a second direction; the second direction is intersected with the first direction and located in a same plane with the first direction; the first width is larger than the second width.

As an improvement, a cross section of the housing along the second direction is quadrilateral; the housing includes a first corner portion and a second corner portion arranged along the second direction, and a third corner portion arranged diagonally opposite the first corner portion; an end of the frame along the first direction is fixed to the first corner portion, the other end of the frame along the first direction is fixed to a portion of the frame between the second corner portion and the third corner portion.

As an improvement, an end of the frame along the first direction is fixed to the first corner portion, the other end of the frame along the first direction is fixed to the third corner portion.

As an improvement, the magnet system includes a first yoke fixed to the frame, a main magnet mounted on a side of the first yoke facing the diaphragm, and a side magnet spaced apart from the main magnet; a junction of a surface of the side magnet facing the first yoke and a surface of the side magnet away from the main magnet along the first direction is chamfered.

As an improvement, the side magnet includes a first surface fixed to the first yoke, a second surface away from the main magnet along the first direction and parallel to the vibration direction, a third surface connected the first surface with the second surface; the third surface extends from an edge of the first surface towards the second surface along a direction facing the diaphragm and away from the main magnet.

As an improvement, the first yoke includes a bottom portion fixed to the main magnet, a side portion bending and extending from an edge of the bottom portion towards the diaphragm, and an extension portion bending and extending from an end of the side portion along the first direction away from the main magnet; the first surface of the side magnet is fixed to a side of the extension portion facing the diaphragm.

As an improvement, the magnet system further includes a second yoke mounted on a surface of the main magnet away from the bottom portion, and a central magnet mounted on a surface of the second yoke away from the main magnet.

As an improvement, the housing includes a top cover, and a bottom cover enclosed the receiving space with the top cover; the top cover includes a top wall opposite to the bottom cover, and a side wall connected the top wall and the bottom cover; the support wall is disposed on the side wall; the front sound cavity is enclosed by the diaphragm and the top cover; the sound hole is disposed on the side wall.

As an improvement, an amount of the side magnet is two; the two side magnets are located on two sides of the main magnet along the first direction; the third surface of one of the two side magnets closer to the main magnet is spaced apart from the bottom cover.

As an improvement, the side wall includes a leakage hole penetrating thereon; the leakage hole is configured to connected the back sound cavity with outside.

The other object of the present disclosure is to provide a smart wearable eyeglass including an eyeglass frame, and the smart wearable eyeglass temple as described above; the smart wearable eyeglass temple is mounted on the eyeglass frame.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a smart wearable eyeglass temple in accordance with an exemplary embodiment of the present disclosure.

FIG. 2 is a top view of the smart wearable eyeglass temple in FIG. 1 removing a bottom cover.

FIG. 3 is an exploded view of part of the smart wearable eyeglass temple in FIG. 1.

FIG. 4 is an exploded view of the smart wearable eyeglass temple in FIG. 1.

FIG. 5 is a cross-sectional view of the smart wearable eyeglass temple taken along line A-A in FIG. 1.

FIG. 6 is a cross-sectional view of the smart wearable eyeglass temple taken along line A-A in FIG. 1.

FIG. 7 is an exploded view of a magnet unit of the smart wearable eyeglass temple in FIG. 1.

FIG. 8 is an isometric view of a smart wearable eyeglass in accordance with an exemplary embodiment of the present disclosure.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

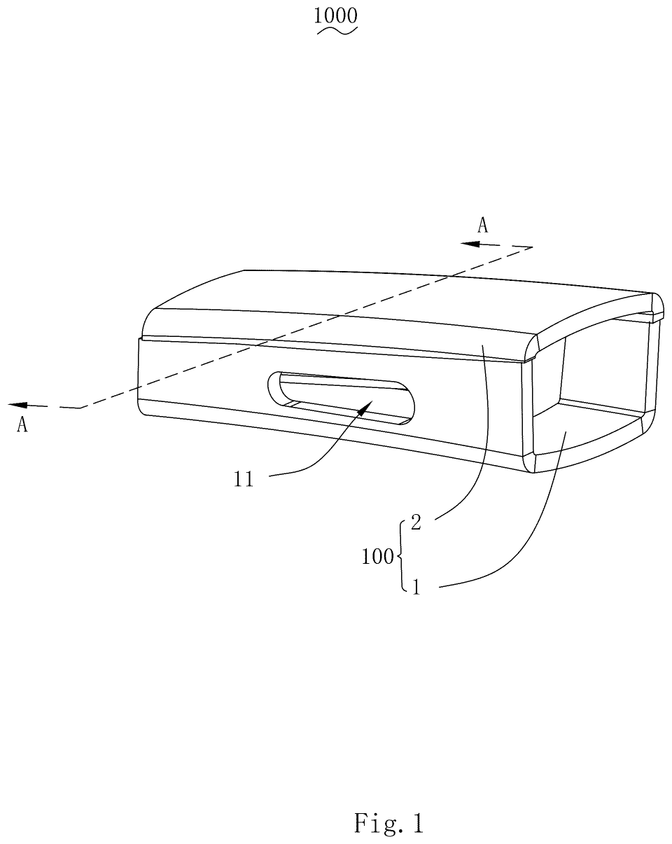

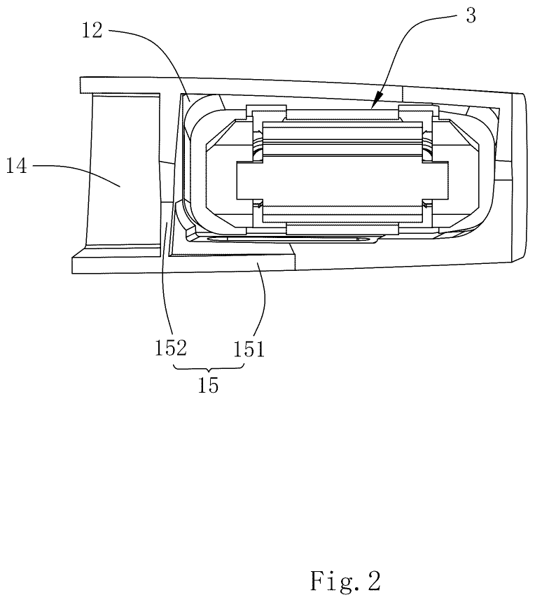

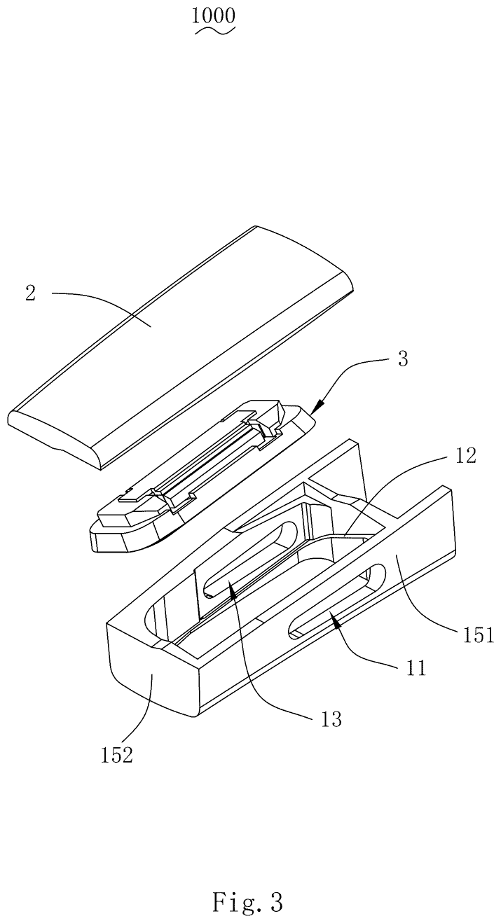

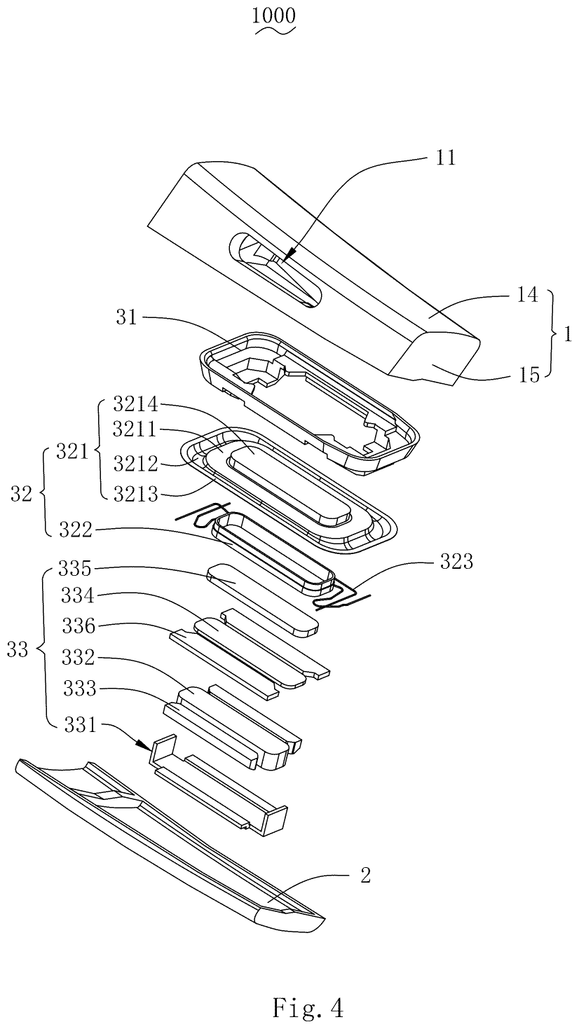

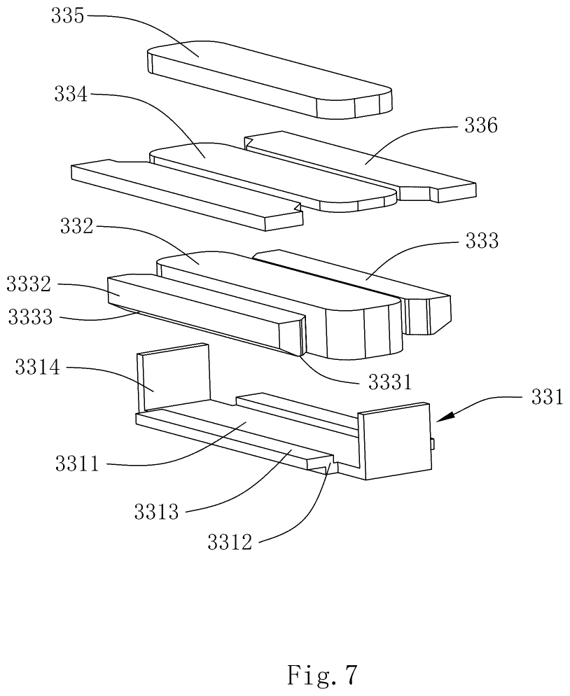

Please refer to FIGS. 1-7 together, a smart wearable eyeglass temple 1000 provided by an exemplary embodiment of the present disclosure includes a housing 100 having a receiving space 101, and a speaker unit 3 received in the receiving space 101. A sound hole 11 is provided on the housing 100 by penetrating thereon. The sound wave generated by the speaker unit 3 is transmitted to outside through the sound hole 11.

The housing 100 includes a top cover 1, and a bottom cover 2 enclosed the receiving space 101 with the top cover 1. Furthermore, the housing 100 includes an inner surface 102 enclosing the receiving space 101, and a support wall 12 extending from the inner surface 102. The support wall 12 is hollow. The speaker unit 3 is mounted on the support wall 12. The sound hole 11 is disposed on the top cover 1.

Specifically, the speaker unit 3 includes a frame 31 mounted on the support wall 12, a vibration system 32 mounted in the frame 31, and a magnet system 33 configured to drive the vibration system 32. The support wall 12 extends from the top cover 1 towards the bottom cover 2. The vibration system 32 is closer to the top cover 1 than the magnet system 33.

The vibration system 32 includes a diaphragm 321 sandwiched between the frame 31 and the support wall 12, and a coil 322 fixed on a side of the diaphragm 321 facing the magnet system 33. In one embodiment, an edge of the diaphragm 321 is fixed on the frame 31. The diaphragm 321 divides the receiving space 101 into a front sound cavity 10 and a back sound cavity 30 isolated from each other. The front sound cavity 10 is enclosed by the diaphragm 321 and the top cover 1. The magnet system 33 is received in the back sound cavity 30. The sound hole 11 is connected with the front sound cavity 10 for forming a front cavity 20.

The diaphragm 321 includes a hollow vibration portion 3211, a suspension portion 3212 bending and extending from an outer edge of the vibration portion 3211, a fixation portion 3212 extending from an outer edge of the suspension portion 3212 towards the frame 31, and a dome 3214 fixed to a side of the vibration portion 3211 closer to the magnet system 33. The fixation portion 3213 is located between the frame 31 and the support wall 12. Two ends of the coil 322 are electrically activated by an electrical signal input through connection wires 323.

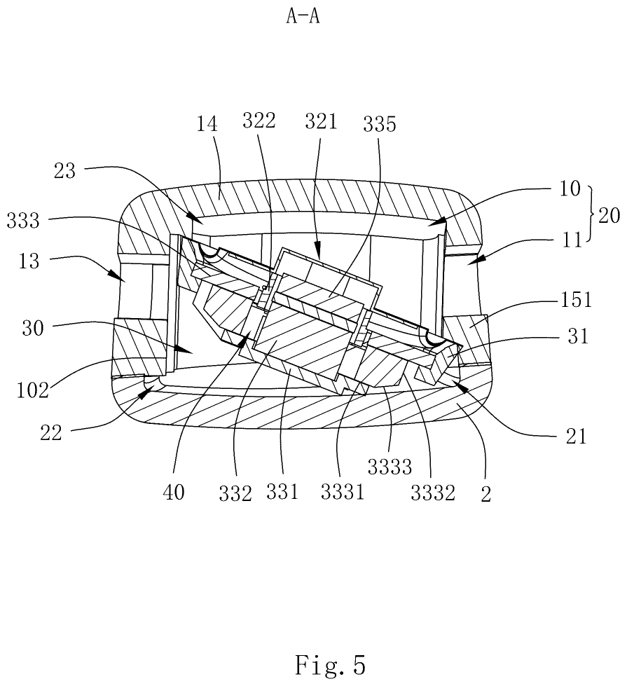

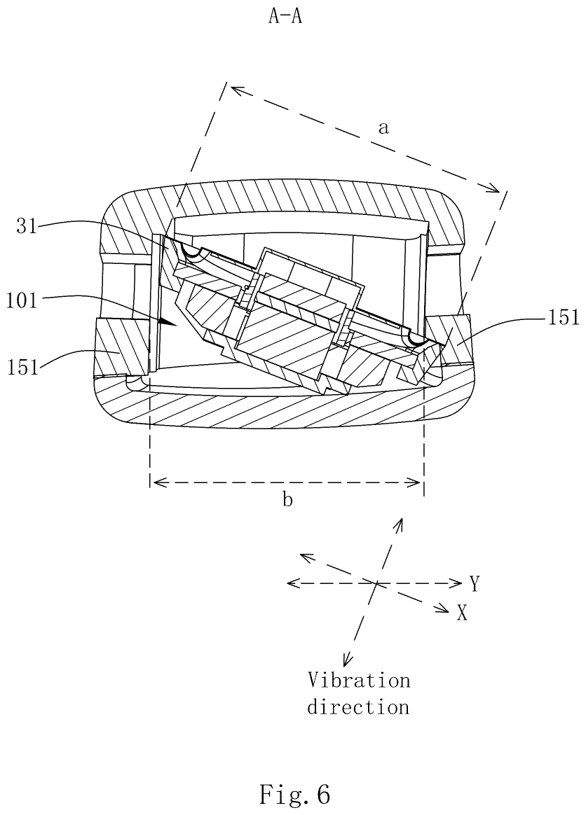

In particular, as shown in FIGS. 5-6, the frame 31 has a first width labeled a along a first direction X perpendicular with a vibration direction of the diaphragm 321. The inner surface 302 has a second width labeled b along a second direction Y intersected with the first direction X and located in a same plane with the first direction X. The first width is larger than the second width. Therefore, the speaker unit 3 is placed in the receiving space 101 of the housing 100 in a tilted state, thus enabling a larger size speaker unit being placed in the housing having same width. Besides, a magnet unit with larger volume and a diaphragm with larger area can be provided, thus improving the acoustic performance of the speaker unit.

Moreover, a cross section of the inner surface 302 along the second direction Y is quadrilateral. The housing 100 includes a first corner portion 21 and a second corner portion 22 arranged along the second direction Y, and a third corner portion 23 arranged diagonally opposite the first corner portion 21. An end of the frame 31 along the first direction X is fixed to the first corner portion 21, the other end of the frame 31 along the first direction X is fixed to a portion of the frame 31 between the second corner portion 22 and the third corner portion 23.

Optionally, an end of the frame 31 along the first direction X is fixed to the first corner portion 21, the other end of the frame 31 along the first direction X is fixed to the third corner portion 23. In this manner, a speaker unit with larger width can be provided in the housing 100. In one embodiment, the cross section of the inner surface 102 of the housing 100 along the second direction Y is rectangular.

In addition, the top cover 1 includes a top wall 14 opposite to the bottom cover 2, and a side wall 15 connected the top wall 14 and the bottom cover 2. In one embodiment, the housing 100 is quadrilateral. The side wall 15 includes two first walls 151 opposite to each other along the second direction Y, and two second walls 152. The second width is a distance between the two first walls 151 along the second direction Y. The sound hole 11 is provided on one of the two first walls 151.

Furthermore, the magnet system 33 includes a first yoke 331 fixed to the frame 31, a main magnet 332 mounted on a side of the first yoke 331 facing the diaphragm 321, and a side magnet 333 spaced apart from the main magnet 332. In one embodiment, an amount of the side magnet 333 is two. The two side magnets 333 are located on two sides of the main magnet 332 along the first direction X.

The first yoke 331 includes a bottom portion 3311 fixed to the main magnet 332, a side portion 3312 bending and extending from an edge of the bottom portion 3311 towards the diaphragm 321, and an extension portion 3313 bending from an end of the side portion 3312 away from the bottom portion 3311 and then extending along the first direction X away from the main magnet 332.

An amount of the side portion 3312 is two. The two side portions 3312 are located on two sides of the bottom portion 3311. The first yoke 331 further includes two flanges 3314 spaced part from the main magnet 332. A magnetic gap 40 is formed between the side magnet 333 and the flange 3314, and between the side magnet 333 and the main magnet 332. The coil 322 is inserted into the magnetic gap 40.

A junction of a surface of the side magnet 333 facing the first yoke 331 and a surface of the side magnet 333 away from the main magnet 332 along the first direction is chamfered to match the shape of magnet system 33 with the receiving space 101, thus maximizing a thickness of a middle region of magnet system 33 to improve the magnetic performance of the magnet system 33. Optionally, the first yoke 331 and the main magnet 332 could be thickened.

The side magnet 333 includes a first surface 3331 fixed to the first yoke 331, a second surface 3332 away from the main magnet 332 along the first direction X and parallel to the vibration direction, a third surface 3333 connected the first surface 3331 with the second surface 3332. The third surface 3333 extends from an edge of the first surface 3331 towards the second surface 3332 along a direction facing the diaphragm 321 and away from the main magnet 332. The first surface 3331 of the side magnet 333 is fixed to a side of the extension portion 3313 towards the diaphragm 321. The third surface 3333 of one of the two side magnets 333 closer to the main magnet 332 is spaced apart from the bottom cover 2.

It should be understood that the bottom portion 3311 is further from the diaphragm 321 than extension portion 3313. Thus, the space between the diaphragm 321 and the bottom portion 3311 is larger to increase the volume of the main magnet 332, thereby improving the magnetic performance of the magnet system 33. Furthermore, the magnet system 33 further includes a second yoke 334 mounted on a surface of the main magnet 332 away from the bottom portion 3311, and a central magnet 335 mounted on a surface of the second yoke 334 away from the main magnet 332, and a side yoke 336 mounted on a side of the side magnet 333 away from the first yoke 331.

Besides, an area of the dome 3214 opposite to the central magnet 335 is dent away from the magnet 33 along the vibration direction to provide more space for the central magnet 335.

In one embodiment, the sound hole 11 is located on a side of the smart wearable eyeglass temple 1000 closer to user ear. Furthermore, a leakage hole 13 is disposed on one of the side walls 151 without the sound hole 11. The leakage hole 13 is configured to connect the back sound cavity 30 with outside. The leakage hole 13 is located on a side of the smart wearable eyeglass temple 1000 away from user ear. Due to the opposite phase of the sound wave emitted from the leakage hole 13 and the sound wave emitted from the sound hole 11, the sound wave emitted from the leakage hole 13 can be offset, thus reducing sound leakage.

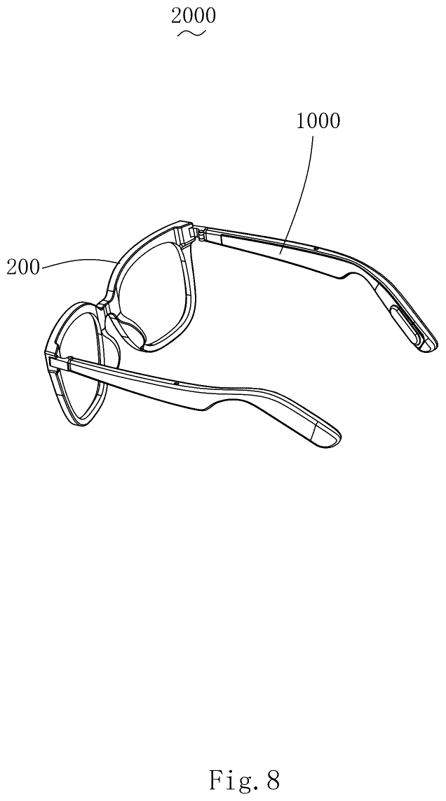

As shown in FIG. 8, a smart wearable eyeglass 2000 is provided in the present disclosure. The smart wearable eyeglass 2000 includes an eyeglass frame 200, and the smart wearable eyeglass temple 1000 as described above. The mart wearable eyeglass temple 1000 is mounted on two sides of the eyeglass frame 200.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A smart wearable eyeglass temple comprising:
a housing having a receiving space and a sound hole penetrating thereon, including:
an inner surface enclosing the receiving space; and
a support wall extending from the inner surface;
a speaker unit received in the receiving space, comprising:
a frame mounted on the support wall;
a vibration system mounted on the frame, comprising:
a diaphragm for generating sound, dividing the receiving space into a front sound cavity and a back sound cavity, and including an edge fixed on the frame;
a magnet system configured to drive the vibration system, received in the back sound cavity; wherein
the sound hole is configured to connected the front sound cavity with outside;
the frame has a first width along a first direction perpendicular with a vibration direction of the diaphragm; the inner surface has a second width along a second direction; the second direction is intersected with the first direction and located in a same plane with the first direction; the first width is larger than the second width.

2. The smart wearable eyeglass temple as described in claim 1, wherein a cross section of the housing along the second direction is quadrilateral; the housing comprises a first corner portion and a second corner portion arranged along the second direction, and a third corner portion arranged diagonally opposite the first corner portion; an end of the frame along the first direction is fixed to the first corner portion, the other end of the frame along the first direction is fixed to a portion of the frame between the second corner portion and the third corner portion.

3. The smart wearable eyeglass temple as described in claim 2, wherein an end of the frame along the first direction is fixed to the first corner portion, the other end of the frame along the first direction is fixed to the third corner portion.

4. The smart wearable eyeglass temple as described in claim 1, wherein the magnet system comprises a first yoke fixed to the frame, a main magnet mounted on a side of the first yoke facing the diaphragm, and a side magnet spaced apart from the main magnet; a junction of a surface of the side magnet facing the first yoke and a surface of the side magnet away from the main magnet along the first direction is chamfered.

5. The smart wearable eyeglass temple as described in claim 4, wherein the side magnet comprises a first surface fixed to the first yoke, a second surface away from the main magnet along the first direction and parallel to the vibration direction, a third surface connected the first surface with the second surface; the third surface extends from an edge of the first surface towards the second surface along a direction facing the diaphragm and away from the main magnet.

6. The smart wearable eyeglass temple as described in claim 5, wherein the first yoke comprises a bottom portion fixed to the main magnet, a side portion bending and extending from an edge of the bottom portion towards the diaphragm, and an extension portion bending from an end of the side portion away from the bottom portion and then extending along the first direction away from the main magnet; the first surface of the side magnet is fixed to a side of the extension portion facing the diaphragm.

7. The smart wearable eyeglass temple as described in claim 6, wherein the magnet system further comprises a second yoke mounted on a surface of the main magnet away from the bottom portion, and a central magnet mounted on a surface of the second yoke away from the main magnet.

8. The smart wearable eyeglass temple as described in claim 6, wherein the housing comprises a top cover, and a bottom cover enclosed the receiving space with the top cover; the top cover comprises a top wall opposite to the bottom cover, and a side wall connected the top wall and the bottom cover; the support wall is disposed on the side wall; the front sound cavity is enclosed by the diaphragm and the top cover; the sound hole is disposed on the side wall.

9. The smart wearable eyeglass temple as described in claim 8, wherein an amount of the side magnet is two; the two side magnets are located on two sides of the main magnet along the first direction; the third surface of one of the two side magnets closer to the main magnet is spaced apart from the bottom cover.

10. The smart wearable eyeglass temple as described in claim 8, wherein the side wall comprises a leakage hole penetrating thereon; the leakage hole is configured to connect the back sound cavity with outside.

11. A smart wearable eyeglass, comprising an eyeglass frame and the smart wearable eyeglass temple as described in claim 1; the smart wearable eyeglass temple is mounted on the eyeglass frame.
